(19) United States
(12) Patent Application Publication
(10) Pub. No.: US 2009/0038221 A1
(43) Pub. Date: Feb. 12, 2009

(54) OUTDOOR GARDEN APPARATUS AND RELATED METHODS

(75) Inventor: James H. Poore, JR., Lakeland, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignees: Louis Lanzino, Lakeland, FL (US); James H. Poore, JR., Lakeland, FL (US)

(21) Appl. No.: 11/835,896

(22) Filed: Aug. 8, 2007

(51) Int. Cl. A01G 31/00; G08B 1/08

(52) U.S. Cl. 47/62 R; 340/602

(57) ABSTRACT

An outdoor garden apparatus may include a container for containing a plant growing medium therein and having an open top exposed to rainfall, a reservoir filled with nutrient enriched water, and a pump connected in fluid communication between the reservoir and the container. The outdoor garden apparatus may also include a rainfall sensor for detecting rainfall associated with the container, and a controller. The controller may cooperate with the pump for selectively flooding the nutrient enriched water into the container from the reservoir and thereafter draining the nutrient enriched water from the container back into the reservoir. The controller may selectively flood the nutrient enriched water based upon the rainfall sensor.

### FIELD OF THE INVENTION

The present invention relates to the field of soilless growing of plants, and, more particularly, to an outdoor garden apparatus with flooding control and related methods.

### BACKGROUND OF THE INVENTION

The common plant situated in soil, for example, silt or clay based soil, may derive nutrients from the soil when the soil becomes saturated with water. The water may dissolve the nutrients within the soil, which are absorbed by the root structure of the plant. In other words, the soil serves as a nutrient store for the plant situated therein, and the water makes the nutrients available to the plant. Soilless growing methods, for example, hydroponics, provide an approach to replace the soil of traditional growing methods with either nutrient enriched water or an inert non-soil medium, such as, perlite, gravel, or rock wool.

In a hydroponics growing device, the device may comprise a plurality of growing cups for holding each individual plant. Nutrient enriched water may continuously flow through each growing cup, thereby delivering nutrients to the plants. A pump cooperates with a nutrient enriched water reservoir to continuously flow nutrient enriched water through the growing cups. The device may further include respective supporting devices, for example, wires or clips, for each growing cup to support the plant situated therein.

The above mentioned hydroponics growing device may be subject to several drawbacks. For example, as the plants reach maturity and their root structures increase in size and length, the roots may extend into the piping system and restrict the flow of nutrient enriched water to the growing cups. To mitigate this drawback of the hydroponics growing device, a user may routinely remove the plants from their growing cups and trim their roots. The user may also routinely prune the plant as it matures. Additionally, the continuous flow of nutrient enriched water requires a reliable and robust supply of water.

Moreover, since the hydroponics growing device may rely on the continuous flow of nutrient enriched water through the plurality of growing cups, unexpected power failures affecting the pump may provide another drawback. Accordingly, many hydroponics growing devices may comprise complex backup power generators to maintain the continuous flow of nutrient enriched water through the growing cups. Nonetheless, when the power generator is exhausted, the plants may not survive without the continuous flow of nutrient enriched water.

Furthermore, the plurality of growing cups may limit the number of plants that may be situated and grown in the device as each cup may hold a single plant. Given that the growing cups may be relatively small sized, another drawback may comprise an inability to tolerate typical outdoor weather, for example, rainfall. In other words, the hydroponics growing device may not be particularly robust when used outdoors.

U.S. Pat. No. 5,307,589 to Rigsby discloses a soilless system for growing vegetation comprising a plurality of growing cups with granular growing medium therein, and a pump and reservoir system. Each growing cup is situated in a larger second container, the larger container being flooded periodically to submerge the respective growing cup. Rigsby discloses collecting the rainwater from the second container.

U.S. Pat. No. 6,233,870 to Horibata discloses the pump and reservoir system periodically flooding a ditch with plants with a nutrient enriched water based solution, and returning the solution back to the system for future use. The plants are also individually situated in respective growing cups. Horibata discloses collecting rainwater from an underground well.

### SUMMARY OF THE INVENTION

In view of the foregoing background, it is therefore an object of the present invention to provide an outdoor garden apparatus for growing plants effectively and efficiently.

This and other objects, features, and advantages in accordance with the present invention are provided by an outdoor garden apparatus for growing plants. The outdoor garden apparatus may comprise a container for containing a plant growing medium therein and having an open top exposed to rainfall, a reservoir filled with nutrient enriched water, a pump connected in fluid communication between the reservoir and the container, a rainfall sensor for detecting rainfall associated with the container, and a controller. The controller may be for cooperating with the pump for selectively flooding the nutrient enriched water into the container from the reservoir and thereafter draining the nutrient enriched water from the container back into the reservoir, and based upon the rainfall sensor. The controller may selectively flood the container on a periodic time schedule, for example. The controller may also prevent flooding during rainfall. Advantageously, the controller may prevent the container from overflowing during flooding while subjected to simultaneous rainfall. Moreover, the controller may prevent the plant growing medium from becoming oversaturated.

Additionally, the outdoor garden apparatus may also comprise a return conduit connected in fluid communication between the container and the reservoir. The outdoor garden apparatus may further comprise at least one fluid nipple connected in fluid communication with the pump and extending a predetermined height into the container to set a minimum nutrient enriched water level therein. Advantageously, when the outdoor garden apparatus is subjected to a prolonged outage, the plant growing medium maintains a threshold saturation level due to the remaining nutrient enriched water in the container.

Moreover, the outdoor garden apparatus may also comprise a rainfall reservoir, a first valve between the pump and the container, and a second valve between the rainfall reservoir and the container. The controller selectively operates the first and second valves to collect rainfall into the rainfall reservoir based upon the rainfall sensor. Advantageously, the outdoor garden apparatus may collect rainfall for use.

In certain embodiments, the outdoor garden apparatus may also comprise a water aerator associated with the reservoir for oxygenating the nutrient enriched water therein. The pump may also be submerged within the reservoir. The outdoor garden apparatus may further include a back-up battery power supply coupled to the pump and the controller.

The outdoor garden apparatus may further comprise a mesh substrate within the container for supporting the plants, and a movable frame supporting the container. The outdoor garden apparatus may also include at least one removable fluid coupling carried by the container. Advantageously, the container may be readily disconnected from the outdoor garden apparatus and moved.

The container may also comprise an undivided contiguous container having a plurality of plants growing therein. Advantageously, the outdoor garden apparatus may grow a plurality of plants without the need for individual growing cups.

Another aspect is directed to an outdoor gardening method for growing plants. The method may comprise positioning a plant growing medium in a container having an open top exposed to rainfall, filling a reservoir with nutrient enriched water, coupling a pump in fluid communication between the reservoir and the container, and associating a rainfall sensor for detecting rainfall with the container. The method may also include using a controller cooperating with the pump for selectively flooding the nutrient enriched water into the container from the reservoir and thereafter draining the nutrient enriched water from the container back into the reservoir, and based upon the rainfall sensor.

### BRIEF DESCRIPTION OF THE DRAWINGS

FIG. 1A is a schematic diagram of the outdoor garden apparatus according to the present invention.

FIG. 1B is a schematic diagram of the outdoor garden apparatus, as shown in FIG. 1A, during a scheduled flooding.

FIG. 1C is a schematic diagram of the outdoor garden apparatus, as shown in FIG. 1A, after a scheduled flooding.

FIG. 1D is a schematic diagram of another embodiment of the outdoor garden apparatus according to the present invention.

FIG. 2A is a flowchart of the program for the controller of the outdoor garden apparatus, as shown in FIG. 1A.

FIG. 2B is a flowchart of the program for the controller of the outdoor garden apparatus, as shown in FIG. 1D.

FIG. 3 is a schematic diagram of the container of the outdoor garden apparatus, as shown in FIG. 1A.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

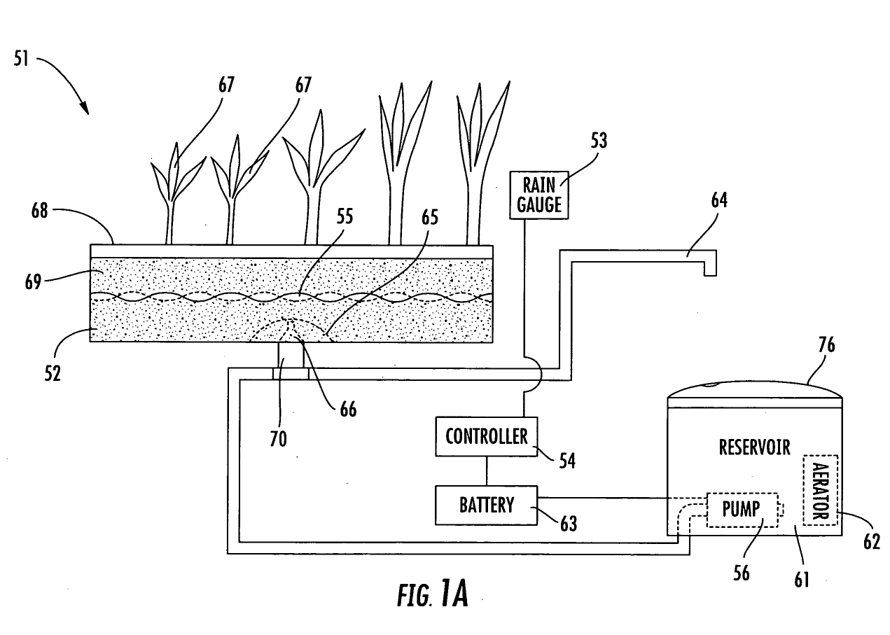

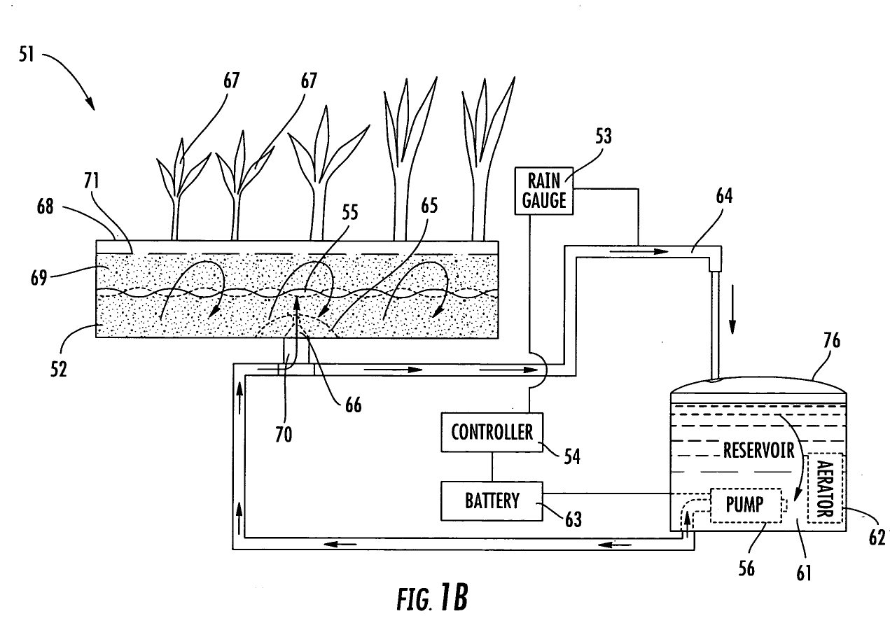

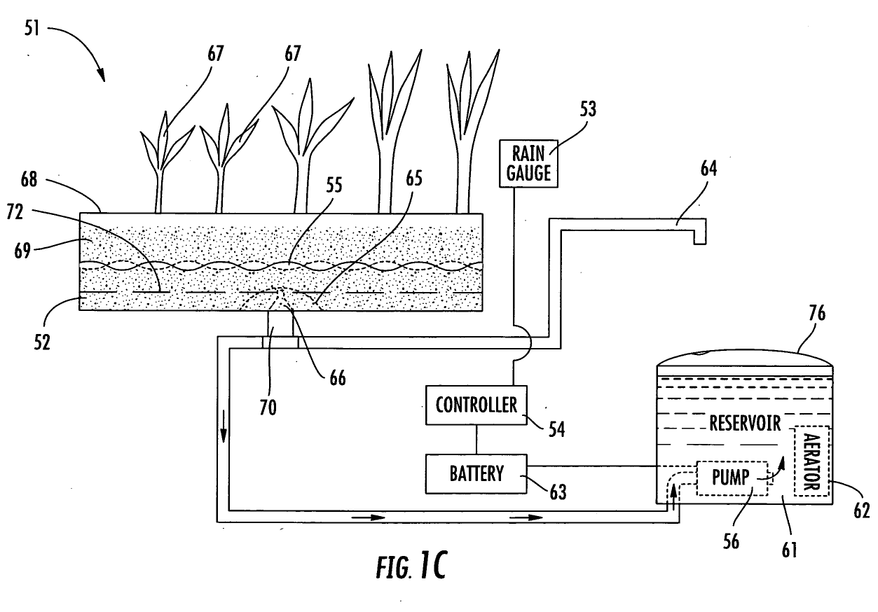

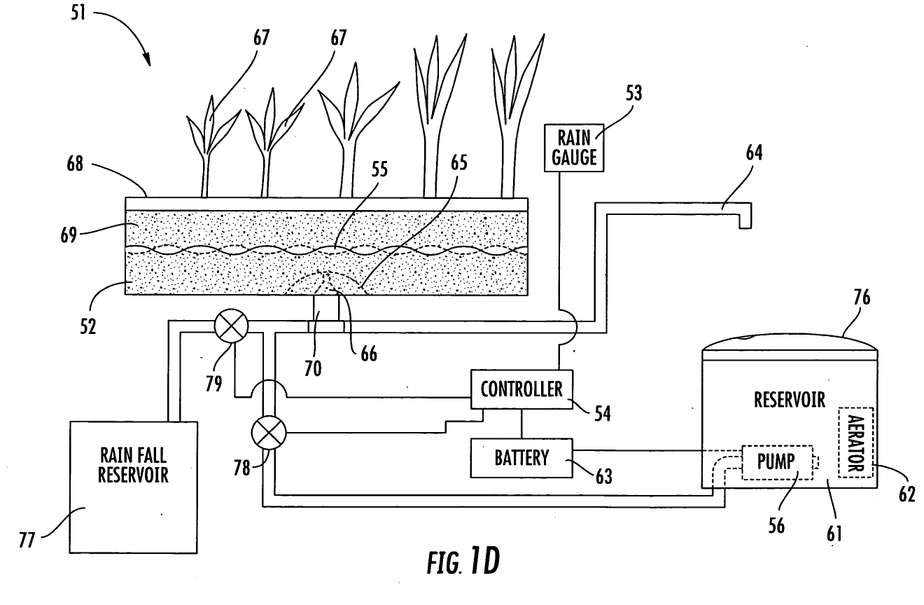

Referring initially to FIG. 1A, an outdoor garden apparatus 51 for growing plants 67 is now described. The outdoor garden apparatus 51 illustratively includes a container 52 for containing a plant growing medium 69 therein and having an open top 68 exposed to rainfall. As will be appreciated by a person skilled in the art, the container 52 may comprise injection molded plastic, for example, and the container may be readily formed into any shape or size suitable for a particular application. For example, the container 52 may be formed as a cylinder having an open top 68, a diameter of 44 inches, and a height of 9 inches.

The outdoor garden apparatus 51 illustratively includes a reservoir 61 for nutrient enriched water. The reservoir 61 includes a closed top 76 for preventing rainfall from entering the reservoir and diluting the nutrient enriched water therein. The closed top 76 also reduces loss of the nutrient enriched water due to evaporation. Nonetheless, in some configurations, the outdoor garden apparatus 51 may be situated indoors and thereby not exposed to rainfall, i.e. the reservoir 61 may include an open top (not shown). The closed top 76 may include a closable a first opening (not shown) for maintaining the nutrient level of the nutrient enriched water.

Furthermore, the outdoor garden apparatus 51 illustratively includes a pump 56 connected in fluid communication between the reservoir 61 and the container 52, a rainfall sensor 53 for detecting rainfall associated with the container, and a controller 54. The outdoor garden apparatus 51 illustratively includes a return conduit 64 connected in fluid communication between the container 52 and the reservoir 61.

Referring additionally to FIGS. 1B and 1C, the controller 54 cooperates with the pump 56 for selectively flooding the nutrient enriched water into the container 52 from the reservoir 61, as illustrated in FIG. 1B. Thereafter, the controller 54 cooperates with the pump 56 to drain the nutrient enriched water from the container 52 back into the reservoir 61, as illustrated in FIG. 1C. The controller 54 may selectively flood the nutrient enriched water based upon the rainfall sensor 53. In other embodiments, the controller 54 may selectively flood the container 52 on a periodic time schedule. For example, the controller may periodically flood the container for a set period of time for saturating the plant growing medium 69. The controller 54 may modify the set period of time or the scheduling of the flooding. This modification may be performed in real time and based upon environmental factors. As will be appreciated by the person skilled in the art, the set period of time for the flooding of the container 52 may also be based upon the water absorption properties of the plant growing medium 69.

As illustrated in FIG. 1B, during the flooding of the container 52, the controller 54 activates the pump 56 to flow the nutrient enriched water from the reservoir 61 to the container at a desired flood water level 71. The desired flood water level 71 may be adjusted by changing the relative vertical elevation of the return conduit 64. Advantageously, as illustrated with arrows in FIG. 1B, the nutrient enriched water is continuously exchanged from the reservoir 61, where the nutrient enriched water is refreshed, to the container 52 during the scheduled flooding.

The outdoor garden apparatus 51 illustratively includes at least one fluid nipple 66 connected in fluid communication with the pump 56 and extending a predetermined height into the container 52 to set a minimum nutrient enriched water level 72 (FIG. 1C) therein. Advantageously, when the outdoor garden apparatus 51 is subjected to prolonged power outages, the plant growing medium 69 maintains a threshold saturation level due to the remaining nutrient enriched water in the container 52.

The outdoor garden apparatus 51 illustratively includes a screen 65 over the at least one fluid nipple 66 for preventing the plant growing medium 69 from entering the piping of the outdoor garden apparatus and preventing the roots of the plants 67 from impeding the flow of the nutrient enriched water. For example, the screen 65 may comprise a metallic mesh screen. Advantageously, the nutrient enriched water may flow readily into and out of the container 52 as the plants 67 mature and grow.

As illustrated in FIG. 1C, once the scheduled flooding ends, the nutrient enriched water drains from the container 52 back through the at least one fluid nipple 66 and the pump 56 into the reservoir 61. As will be appreciated by the person of ordinary skill in the art, the reservoir is illustratively positioned at a lower vertical elevation than the container, thereby urging the nutrient enriched water into the reservoir 61 when the controller 54 deactivates the pump 56. Alternatively, the pump 56 may comprise a bidirectional pump and may urge the nutrient enriched water from the container 52 to the reservoir 61. Moreover, in the embodiment (not shown) of the outdoor garden apparatus 51 having the bidirectional pump, the reservoir 61 may be positioned at an equivalent vertical elevation to the container 52.

Moreover, the outdoor garden apparatus 51 illustratively includes a water aerator 62 associated with the reservoir 61 for oxygenating the nutrient enriched water therein. Illustratively, the water aerator 62 may be submerged in the reservoir 61. For example, the water aerator 62 may comprise an air stone with an associated air pump. Although the illustrated pump 56 is submerged within the reservoir 61, as will be appreciated by the person of ordinary skill in the art, the pump may be positioned outside the reservoir.

The outdoor garden apparatus 51 illustratively includes a back-up battery power supply 63 coupled to at least one of the pump 56, the controller 54, and the rainfall sensor 53. The back-up battery power supply 63 may comprise a solar power generation device, for example, a photovoltaic module. Advantageously, the outdoor garden apparatus 51 may operate during prolonged power outages and may operate independently of a dedicated power supply.

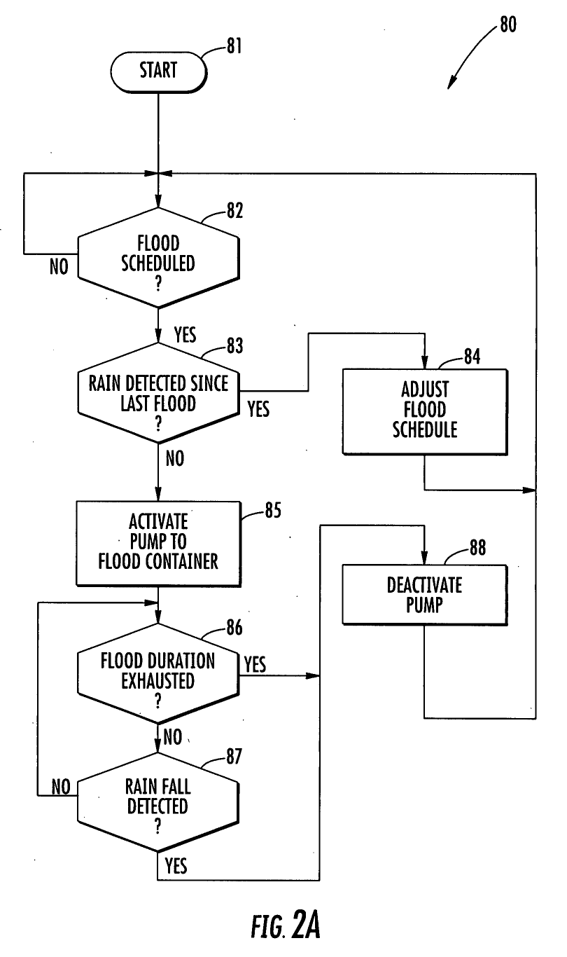

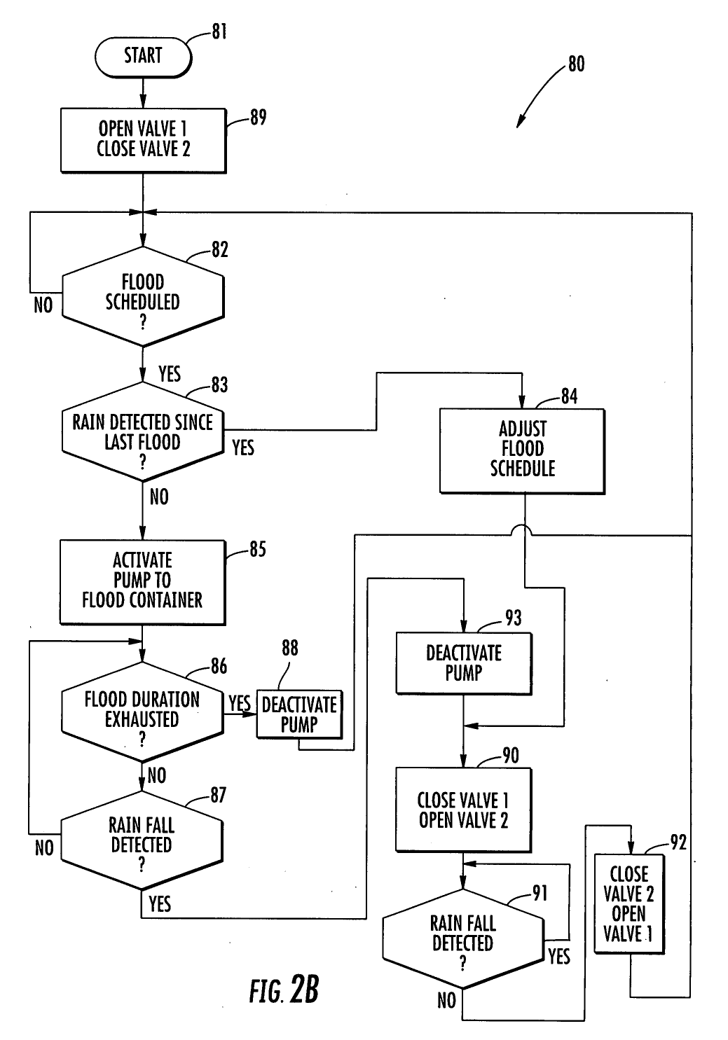

Now referring additionally to FIG. 2A, a flowchart 80 depicting the program of the controller 54 is illustrated. The controller 54 begins (Block 81) by determining whether a flooding is scheduled (Block 82). During a scheduled flooding of the container 52, if the rainfall sensor 53 detects (Block 83) rainfall, the controller 54 adjusts (Block 84) the flood schedule based upon the detected rainfall, for example, by delaying the next scheduled flooding. If no rainfall is detected, the controller 54 activates (Block 85) the pump 56 for a set period of time and floods the container 52, as illustrated in FIG. 1B. As will be appreciated by the person of ordinary skill in the art, the set period of time may be adjusted depending on the nutrient level of the nutrient enriched water and the plant type being grown. After the set period of time has elapsed 86, the controller 54 deactivates (Block 88) the pump 56 and drains the nutrient enriched water from the container 52 to the reservoir 61, as illustrated in FIG. 1C.

During the scheduled flooding, if the rainfall sensor 53 detects (Block 87) rainfall, the controller 54 may deactivate (Block 88) the pump 56 and prematurely end the scheduled flooding. Advantageously, the controller 54 may prevent the container 52 from overflowing during flooding while subjected to rainfall. Moreover, the controller 54 may prevent the growing medium from becoming oversaturated.

Now referring additionally to FIGS. 1D and 2B, another embodiment of the outdoor garden apparatus 51 is depicted. This outdoor garden apparatus 51 illustratively Includes a rainfall reservoir 77 fluidly connected to the container 52, a first valve 78 coupled to the controller 54 and controlling the fluid connection between the container and the reservoir 61, and a second valve 79 coupled to the controller and controlling the fluid connection between the container and the rainfall reservoir.

In this embodiment, when the rainfall sensor 53 detects rainfall during a scheduled flooding (Block 87) or between scheduled floodings (Block 83), the controller 54 deactivates the pump 56 (Block 93) and further closes the first valve 78 and opens the second valve 79 (Block 90), thereby advantageously collecting the rainfall incident the surface of the plant growing medium 69 into the rainfall reservoir 77 and preventing the rainfall from diluting the nutrient enriched water in the reservoir 61. The controller 54 monitors (Block 91) the rainfall sensor 53 until rainfall is no longer detected, the controller then opens the first valve 78 and closes the second valve 79 (Block 92). Otherwise, i.e. during normal operation of the outdoor garden apparatus 51, the controller 54 maintains the first valve 78 open and the second valve 79 closed (Block 89). As will be appreciated by those skilled in the art, the rainfall reservoir 77 may be fluidly connected to the reservoir 61 for replenishing the nutrient enriched water (not shown).

The outdoor garden apparatus 51 illustratively includes a mesh substrate 55 within the container 52 for supporting the plants 67. The mesh substrate 55 may advantageously provide ground support and an anchoring mechanism for the plants 67, thereby providing the support function of traditional soil. Moreover, the mesh substrate 52 may comprise a vinyl sunscreen, for example. The mesh substrate 52 may be removed for growing tuberous plants, for example, potatoes and carrots.

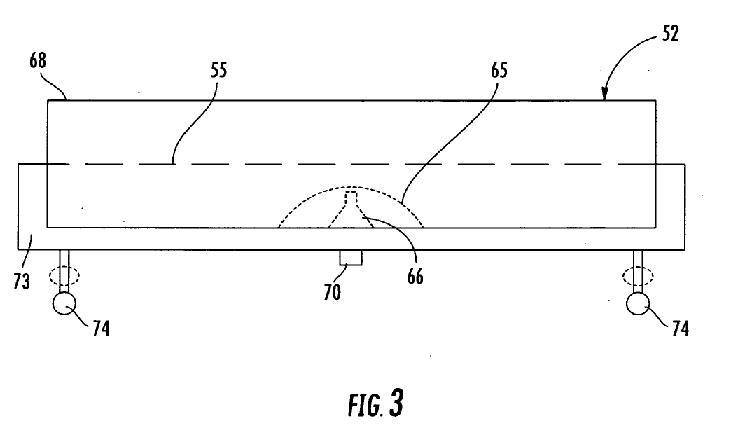

Now referring additionally to FIG. 3, another embodiment of the container 52 is depicted. The outdoor garden apparatus 51 illustratively includes a movable frame 73 supporting the container 52. For example, as depicted in FIG. 3, the movable frame 73 may comprise casters 74. Moreover, the outdoor garden apparatus 51 illustratively includes at least one removable fluid coupling 70 carried by the container 52. Advantageously, the at least one removable fluid coupling 70 may permit the container 52 to be readily separated from the outdoor garden apparatus 51 to be moved indoors, for example.

The container 52 illustratively includes an undivided contiguous container having a plurality of plants 67 growing therein. Advantageously, the outdoor garden apparatus 51 may grow a plurality of plants 67 without the need for individual growing cups, as in the prior art. Moreover, the outdoor garden apparatus 51 may grow plants 67 without the need for routine trimming of the root structures and pruning.

As will be appreciated by the person of ordinary skill in the art, it may be helpful to use a plant support device for supporting vine-type plants, for example, a tomato plant, above the top of the plant growing medium 69. Accordingly, in certain embodiments (not shown), the container 52 may have integrally molded support columns protruding vertically from the bottom of the container into the plant growing medium 69, extending past the top of the plant growing medium. The support columns may comprise openings positioned above the plant growing medium 69 for receiving plant support devices, for example, a metal wire cage. Advantageously, the integrally molded support columns alleviate the problem of corroding the metal plant support devices with the nutrient enriched water.

Another aspect of the invention is directed to an outdoor gardening method for growing plants 67. The method may comprise positioning a plant growing medium 69 in a container 52 having an open top exposed to rainfall, filling a reservoir 61 with nutrient enriched water, coupling a pump 56 in fluid communication between the reservoir and the container, and associating a rainfall sensor 53 for detecting rainfall with the container. The method may also include using a controller 54 cooperating with the pump 56 for selectively flooding the nutrient enriched water into the container 52 from the reservoir 61 and thereafter draining the nutrient enriched water from the container back into the reservoir and based upon the rainfall sensor 53.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An outdoor garden apparatus for growing plants comprising:
a container for containing a plant growing medium therein and having an open top exposed to rainfall;
a reservoir filled with nutrient enriched water;
a pump connected in fluid communication between said reservoir and said container;
a rainfall sensor for detecting rainfall associated with said container; and
a controller for cooperating with said pump for selectively flooding the nutrient enriched water into said container from said reservoir and thereafter draining the nutrient enriched water from said container back into said reservoir and based upon said rainfall sensor.

2. The outdoor garden apparatus according to claim 1 wherein said controller selectively floods said container on a periodic time schedule.

3. The outdoor garden apparatus according to claim 2 wherein said controller prevents flooding during rainfall.

4. The outdoor garden apparatus according to claim 1 further comprising a return conduit connected in fluid communication between said container and said reservoir.

5. The outdoor garden apparatus according to claim 1 further comprising at least one fluid nipple connected in fluid communication with said pump and extending a predetermined height into said container to set a minimum nutrient enriched water level therein.

6. The outdoor garden apparatus according to claim 1 further comprising:
a rainfall reservoir;
a first valve between said pump and said container; and
a second valve between said rainfall reservoir and said container;
said controller selectively operating said first and second valves to collect rainfall into said rainfall reservoir based upon said rainfall sensor.

7. The outdoor garden apparatus according to claim 1 further comprising a water aerator associated with said reservoir for oxygenating the nutrient enriched water therein.

8. The outdoor garden apparatus according to claim 1 wherein said pump is submerged within said reservoir.

9. The outdoor garden apparatus according to claim 1 further comprising a back-up battery power supply coupled to said pump and said controller.

10. The outdoor garden apparatus according to claim 1 further comprising a mesh substrate within said container for supporting the plants.

11. The outdoor garden apparatus according to claim 1 further comprising a movable frame supporting said container; and further comprising at least one removable fluid coupling carried by said container.

12. The outdoor garden apparatus according to claim 1 wherein said container comprises an undivided contiguous container having a plurality of plants growing therein.

13. An outdoor garden apparatus for growing plants comprising:
a container for containing a plant growing medium therein and having an open top exposed to rainfall;
a reservoir filled with nutrient enriched water;
a water aerator associated with said reservoir for oxygenating the nutrient enriched water therein;
a pump connected in fluid communication between said reservoir and said container;
a return conduit connected in fluid communication between said container and said reservoir;
a rainfall sensor for detecting rainfall associated with said container; and
a controller for cooperating with said pump for selectively flooding the nutrient enriched water into said container from said reservoir and thereafter draining the nutrient enriched water from said container back into said reservoir and based upon said rainfall sensor.

14. The outdoor garden apparatus according to claim 13 wherein said controller selectively floods said container on a periodic time schedule, and prevents flooding during rainfall.

15. The outdoor garden apparatus according to claim 13 further comprising at least one fluid nipple connected in fluid communication with said pump and extending a predetermined height into said container to set a minimum nutrient enriched water level therein.

16. The outdoor garden apparatus according to claim 13 further comprising:
a rainfall reservoir;
a first valve between said pump and said container; and
a second valve between said rainfall reservoir and said container;
said controller selectively operating said first and second valves to collect rainfall into said rainfall reservoir based upon said rainfall sensor.

17. The outdoor garden apparatus according to claim 13 wherein said pump is submerged within said reservoir.

18. The outdoor garden apparatus according to claim 13 further comprising a back-up battery power supply coupled to said pump and said controller.

19. An outdoor gardening method for growing plants comprising:
positioning a plant growing medium in a container having an open top exposed to rainfall;
filling a reservoir with nutrient enriched water;
coupling a pump in fluid communication between the reservoir and the container;
associating a rainfall sensor for detecting rainfall with the container; and
using a controller cooperating with the pump for selectively flooding the nutrient enriched water into the container from the reservoir and thereafter draining the nutrient enriched water from the container back into the reservoir and based upon the rainfall sensor.

20. The outdoor gardening method according to claim 19 further comprising using the controller cooperating with the pump for selectively flooding the container on a periodic time schedule, and preventing flooding during rainfall.

21. The outdoor gardening method according to claim 19 further comprising:
fluidly connecting at least one fluid nipple with the pump, the at least one fluid nipple extending a predetermined height into the container to set a minimum nutrient enriched water level therein; and
fluidly connecting a return conduit between the container and the reservoir.

22. The outdoor gardening method according to claim 19 further comprising:
providing a rainfall reservoir, a first valve between the pump and the container, and a second valve between the rainfall reservoir and the container; and
using the controller to selectively operate the first and second valves to collect rainfall into the rainfall reservoir based upon the rainfall sensor.

23. The outdoor gardening method according to claim 19 further comprising positioning a water aerator associated with the reservoir for oxygenating the nutrient enriched water therein.

24. The outdoor gardening method according to claim 19 wherein the pump is submerged within the reservoir.

25. The outdoor gardening method according to claim 19 further comprising coupling a back-up battery power supply to the pump and the controller.

26. The outdoor gardening method according to claim 19 further comprising:
supporting the container with a movable frame; and
providing at least one removable fluid coupling carried by the container.

27. The outdoor gardening method according to claim 19 wherein the container comprises an undivided contiguous container having a plurality of plants growing therein.
